(19) United States
(12) Patent Application Publication
(10) Pub. No.: US 2026/0228699 A1
(43) Pub. Date: Aug. 6, 2026

(54) PHYSICAL MEETING SCHEDULING DISPLAY PANEL

(71) Applicant: Lenovo (United States) Inc., Morrisville, NC (US)

(72) Inventor: Yujia Chen, Durham, NC (US)

(21) Appl. No.: 19/047,538

(22) Filed: Feb. 6, 2025

(51) Int. Cl. G06Q 10/1093; G06F 3/0354; G06F 3/04847; G06F 3/04886

(52) U.S. Cl. CPC G06Q 10/1093; G06F 3/03548; G06F 3/04847; G06F 3/04886

(57) ABSTRACT

A computer implemented method includes displaying a scheduling interface on a scheduling panel associated with a room. The scheduling interface includes a moveable slider. Movement of the moveable slider is sensed and converted into a signal representing a length of time. Release of the moveable slider is detected and ad hoc meeting information is generated in response to release of the moveable slider. The meeting information includes a room identifier, start time, and end time. The meeting information is uploaded into a scheduling system.

### BACKGROUND

Smart meeting room scheduling panels are room scheduler mounted outside of meeting rooms to show the occupancy status and upcoming meeting calendars. The scheduling panels may be connected to an overall scheduling system, so once a meeting reservation has been entered into the scheduling system, meeting information shows up in apps or applications connected to the scheduling system and is viewable on devices, including the meeting room scheduling panels.

People can also reserve the room via the room scheduling panels for an ad hoc meeting. However, for spontaneous or ad hoc meetings where people come across a current reserved meeting room, it can be complicated to use a corresponding room scheduling panel user interface to reserve the room so that the reservation is captured by the scheduling system and shows up on the room's scheduling panel and other devices coupled to the scheduling system.

Such ad hoc meetings are often not captured in the system due to people not taking the time to first hit a reserve button on the scheduling panel, choose and end time from displayed fixed options, and then hit another reserve button which results in both the scheduling panel and the scheduling system showing the room is reserved. It is much easier to just start using the room without reserving the room, which can result in overbooking during busy hours when remote users book the room for the same time.

### SUMMARY

A computer implemented method includes displaying a scheduling interface on a scheduling panel associated with a room. The scheduling interface includes a moveable slider. Movement of the moveable slider is sensed and converted into a signal representing a length of time.

Release of the moveable slider is detected and ad hoc meeting information is generated in response to release of the moveable slider. The meeting information includes a room identifier, start time, and end time. The meeting information is uploaded into a scheduling system.

### BRIEF DESCRIPTION OF THE DRAWINGS

FIG. 1 is a perspective front view of an improved conference room scheduling panel according to an example embodiment.

FIG. 2 is a perspective view showing an alternative means of reserving a conference room using scheduling panel according to an example embodiment.

FIG. 3 is a perspective view of panel showing a desired meeting ending time according to an example embodiment.

FIG. 4 is a perspective view of panel resulting from release of the slider according to an example embodiment.

FIG. 5 is a flowchart illustrating a computer implemented method of scheduling ad hoc meetings via a scheduling panel according to an example embodiment.

FIG. 6 is a perspective view of panel having a dial-based slider according to an example embodiment.

FIG. 7A is a perspective view of panel having a physical slider located on a side of the panel according to an example embodiment.

FIG. 7B is a perspective view of the panel of FIG. 7A resulting from movement of the slider according to an example embodiment.

FIG. 8A is a perspective view of panel having a graphic bar slider on a display portion of the panel according to an example embodiment.

FIG. 8B is a perspective view of the panel of FIG. 8A resulting from release of the slider according to an example embodiment.

FIG. 9 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An improved room scheduling panel includes a time selection slider for user interaction to reserve an associated room for a selected period of time. In one example, the time selection slider is a physical slider button enabling a user to slide the button to select a length of time to reserve room. The room is reserved for a period starting from a current time for the selected length of time upon releasing the slider button.

The use of a physical slider button provides a form of physical tactility to a scheduling interaction with the scheduling panel while simplifying steps to schedule a meeting in the room. The time selection slider makes it easy to share meeting information and corresponding room occupancy information across a scheduling system or platform to prevent double booking of the room.

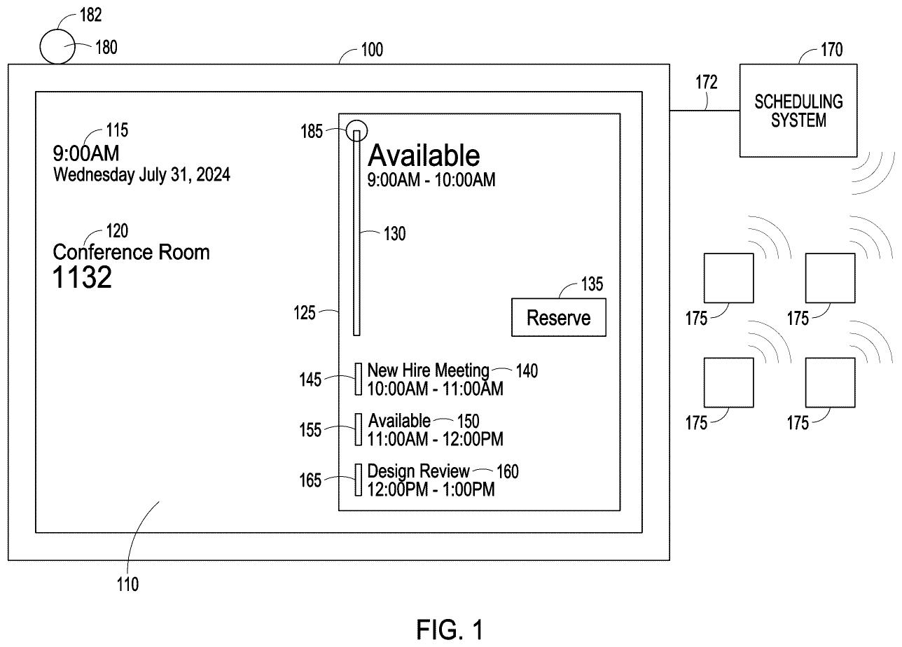

FIG. 1 is a perspective front view of an improved conference room scheduling panel 100. In one example, panel 100 includes a touchscreen display 110 displaying schedule information regarding a schedule corresponding to the conference room. In the example shown, the schedule information includes a current time and date at 115, a conference room identifier at 120 indicating Conference Room 1132, and a section 125 graphically representing availability. Section 125 shows that the conference room is available from 9:00AM, the current time, until 10:00 AM including a green bar 130 having a length representing one hour and a reserve button 135. A New Hire Meeting 140 is also shown with a blue bar 145 and time of 10:00 AM-11:00 AM, followed by an available period 150 with a green bar 155 from 11:00 AM to 12:00 PM, followed by a Design Review meeting 160 with a blue bar 165 from 12:00 PM to 1:00 PM.

Panel 100 may be physically associated with the conference room. Typically, panel 100 is supported on a wall near a door to the conference room and is networked with a scheduling system 170 that includes programming to coordinate scheduling of the conference room and is accessible via a wireless or wired network 172 to both the panel 100 and other devices 175 for viewing scheduling information and status for the conference room as well as other users and rooms. In one example, the scheduling system 170 may be a Teams® scheduling system.

The panel 100 includes a slider 180 that may be a physical button located along the top of the panel 100 as shown or may be an icon, such as a graphic symbol, on the touchscreen display 110. The slider 180 may be used to schedule an ad hoc meeting for a time from the current time up until a next scheduled meeting occurs. In one example the slider 180 may include a light 182, such as a light emitting diode that has a color, such as green, corresponding to the room being available at the current time. Slider 180 is represented by a sphere but may be any shape suitable for contacting by a person and sliding a desired amount up until a time of a next scheduling meeting occurs at which point further sliding will not increase the length of the ad hoc meeting.

In one example, the slider 180 may be an icon 185, such as a graphic symbol, that appears at the top of green bar 130 representing an available time starting with the current time of 9:00 AM as shown. A user may simply contact the icon 185 with a finger and slide the icon 185 down along the green bar 130 which initiates a reserve function. An end time is then determined and displayed based on how far the icon 185 or slider 180 is moved. When a desired length of time is displayed, the person may release the icon 185, causing a reservation to be entered into the reservation system and reflected on the panel 100.

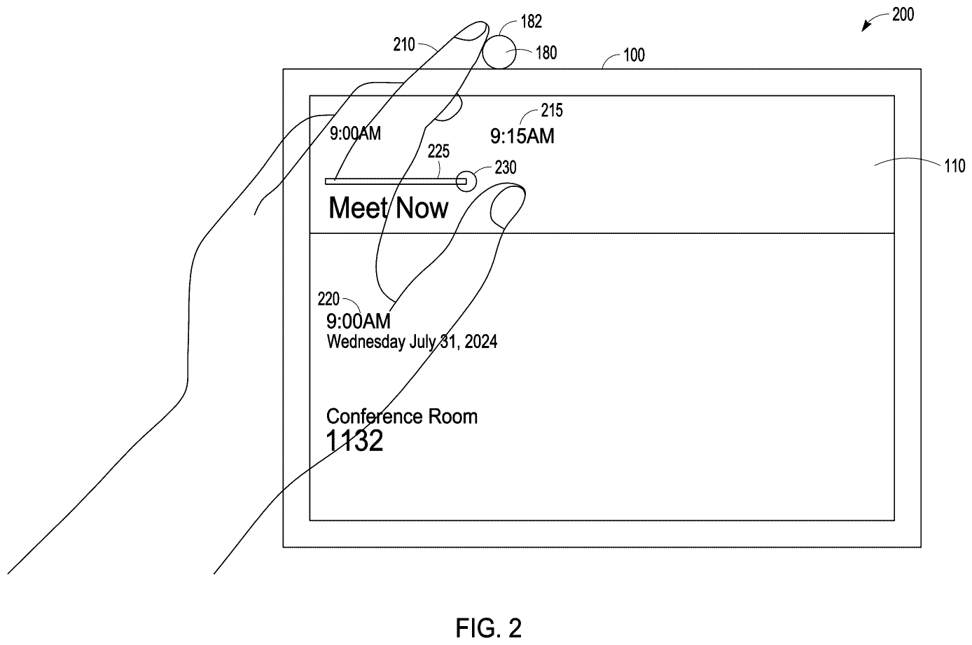

FIG. 2 is a perspective view showing an alternative means of reserving a conference room using scheduling panel 100 for an ad hoc meeting generally at 200. To schedule an ad hoc meeting, such as a meeting that is unscheduled and not reflected in the scheduling system 170, a person may select the reserve button 135 as shown in FIG. 1. Touchscreen display 110 now shows a screen for scheduling the ad hoc meeting with the slider 180 being slide to the right by a user finger 210.

When a room is empty the color green of the light 182 or the icon 185 may be used to indicate room availability. If someone sees the room is empty and wants to use it, they can move the slider 180 to select a desired meeting time, on the touchscreen display 110. An end time 215 selected will show the slider is moved. The end time 215 is currently shown as 9:15 AM with a start time being the current time 220 of 9:00AM. The person may keep dragging or sliding the slider 180 until a desired meeting end time 215 is reached. A colored bar 225 may be displayed to graphically represent a length of the ad hoc meeting. The bar 225 may be green during sliding and has a length corresponding to the length that the slider 180 has been moved. The words: “Meet now” may also be displayed to inform a person that the meeting is being scheduled by use of the slider 180.

In a further example, and alternatively to using a physical slider 180, the bar 225 may include an icon 230 located along the bar 225 that the user may drag to adjust the length of the bar 225. The length of the bar 225 may default to 15 minutes as shown, or other time such as 0, 5, or 10 minutes, and dragged in either direction to adjust the desired length of the meeting.

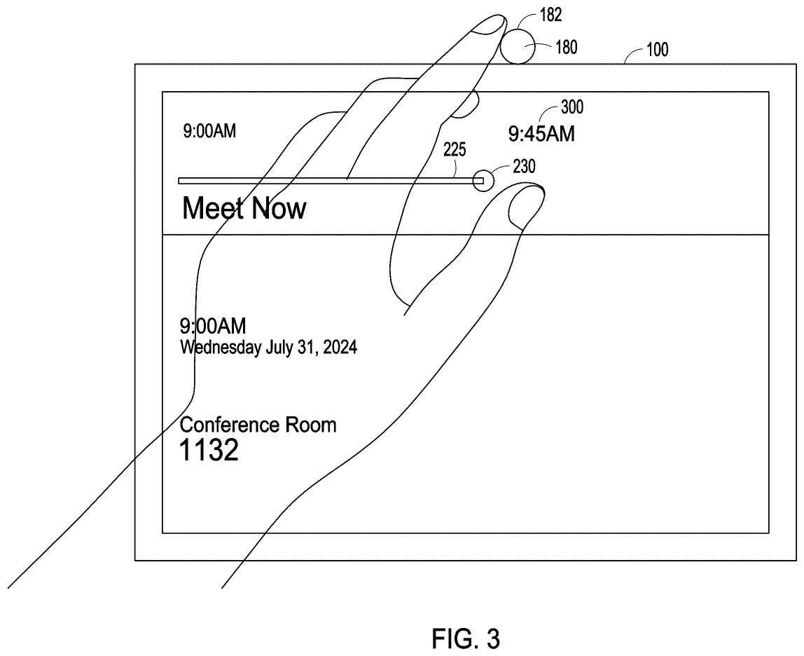

FIG. 3 is a perspective view of panel 100 showing a desired meeting ending time 300 of 9:45 AM selected by sliding the slider 180 to the position shown. The bar 225 is shown longer than in FIG. 2 and corresponding to a later end time being selected. In response to release of the slider 180, the room becomes reserved and scheduling system 170 and touchscreen display 110 are updated to show that the meeting started and the room is reserved up until the end time 300 of 9:45.

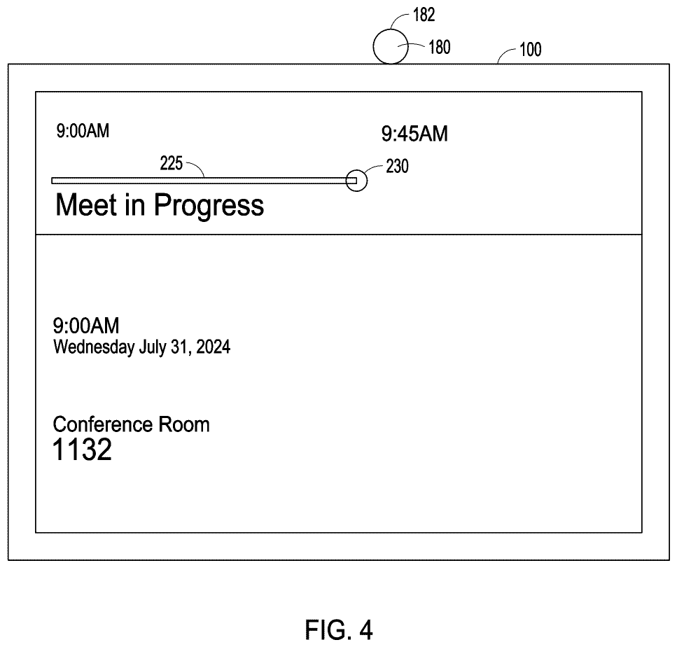

FIG. 4 is a perspective view of panel 100 resulting from release of the slider 180. The bar 225 may now be displayed as a red bar indicating that the meeting is in progress and a now scheduled ad hoc meeting is occurring.

Once the slider 180 is released, the light 182 may also turn red. In one example, the slider 180 and bar 225 may start slowly retracting towards the left to graphically reflect time remaining in the ad hoc meeting. The meeting time information, including a room ID, start time, and end time, is uploaded to the scheduling system 170, making the meeting time information available to devices coupled to the scheduling system 170.

The slider 180 or icon 230 is an interaction point used to initiate a meeting reservation and select a length of time for an ad hoc meeting. The light 182 or color of the bar 225 provide a room status indication of available or scheduled. In one example, as the scheduled ad hoc meeting goes by, the slider 180 or bar 25 may retract back to the original position, giving it a more direct representation of the status and time that is visible form far away. The slider may be implemented as a UI screen or other forms of physical light design.

Clear visual showing current meeting status and time provide a simplified user interface for easy and intuitive meeting registration for spontaneous or ad hoc meetings. The interface helps avoid overbooking by means of its ease of use and in quickly scheduling ad hoc meetings. Use of a physical slider provides physical tactility to encourage interaction, increasing scheduling likelihood. LED retracts as the meeting goes by, the remaining time is easily represented and can be seen from far away, adding an extra dimension to existing features. The slider in further examples may be a physical slider, a raising flag, a circular turning knob or indication, or a color changing nob.

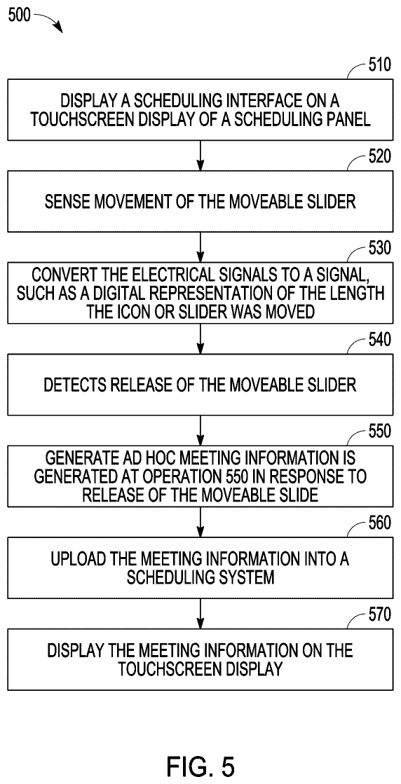

FIG. 5 is a flowchart illustrating a computer implemented method 500 of scheduling ad hoc meetings via a scheduling panel. Method 500 begins at operation 510 by displaying a scheduling interface on a touchscreen display of a scheduling panel associated with a room, the. The scheduling interface includes a moveable slider. Operation 520 senses movement of the moveable slider.

Sensing includes at least one of detecting dragging of an icon on a touchscreen of the scheduling panel or movement of a physical slider in response to signals electrical generated by such movement.

Operation 530 converts the electrical signals to a signal, such as a digital representation of the length the icon or slider was moved. Operation 540 detects release of the moveable slider. In the case of the slider comprising an icon, release of a finger used to drag the icon results in no further signals being generated by touching the screen. In the case of a physical slider, the physical slider may include capacitive sensing similar to that used in a touchscreen, or release may be detected by no longer detecting movement for a selected amount of time.

Ad hoc meeting information is generated at operation 550 in response to release of the moveable slider. The meeting information may include a room identifier, start time, and end time. Operation 560 uploads the meeting information into a scheduling system. In one example, the start time corresponds to a current time. Operation 570 displays the ad hoc meeting information on the touchscreen display.

A bar may be displayed on the touchscreen display of the scheduling panel, the bar graphically representing a meeting time remaining. The bar may decrease in length as the meeting continues. The bar may have a red color in response to release of the moveable slider, the red color corresponding to a meeting taking place and signifying that the room is not available.

A status of the room may be displayed on the touchscreen display of the scheduling panel. The status identifies current and future scheduled meeting times and open times. Only when a current status indicates the room is available will one be able to schedule an ad hoc meeting.

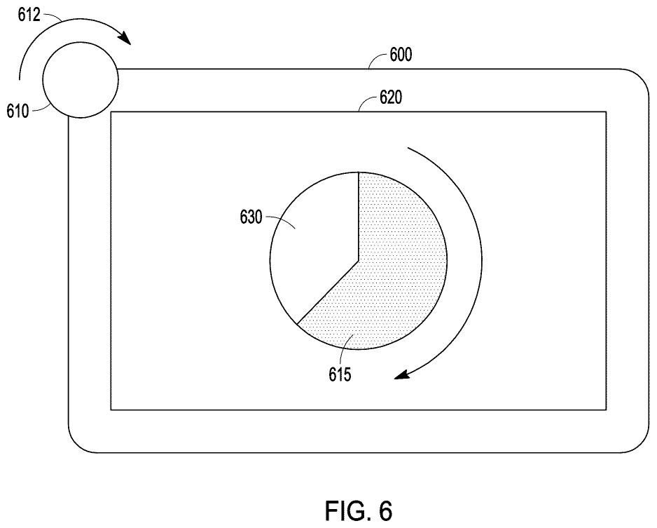

FIG. 6 is a perspective view of panel 600 having a dial-based slider 610 associated with a room. Slider 610 may be a physical dial-based slider that may be supported on a perimeter of the panel 600, such as in a corner of the panel 600 as shown. The dial-based slider 610 may include a green light to show that a corresponding room is currently available.

Turning the dial-based slider 610 clockwise as shown by arrow 612 will result in initiating an ad-hoc reservation of the room and display of a graphic 615 displayed on a display 620 of the panel 600 shown as a circle. A portion of the circle is shown in a darker green portion 625 that grows as the dial-based slider 610 is rotated further, graphically representing a time period for which the room is being reserved. A light green portion 630 shows how much longer the room can be reserved for before a next meeting is already scheduled. Other colors may be used as desired.

A numerical amount of time for the meeting may also be displayed as the dial-based slider is being turned. Release of the dial-based slider 610 or a threshold amount of time for the dial-based slider 610 such as three seconds, results in the meeting being scheduled and the colors of the dial-based slider and at least darker green portion 630 turning red. The darker green portion may reduce in size to reflect the time remaining the ad-hoc reservation.

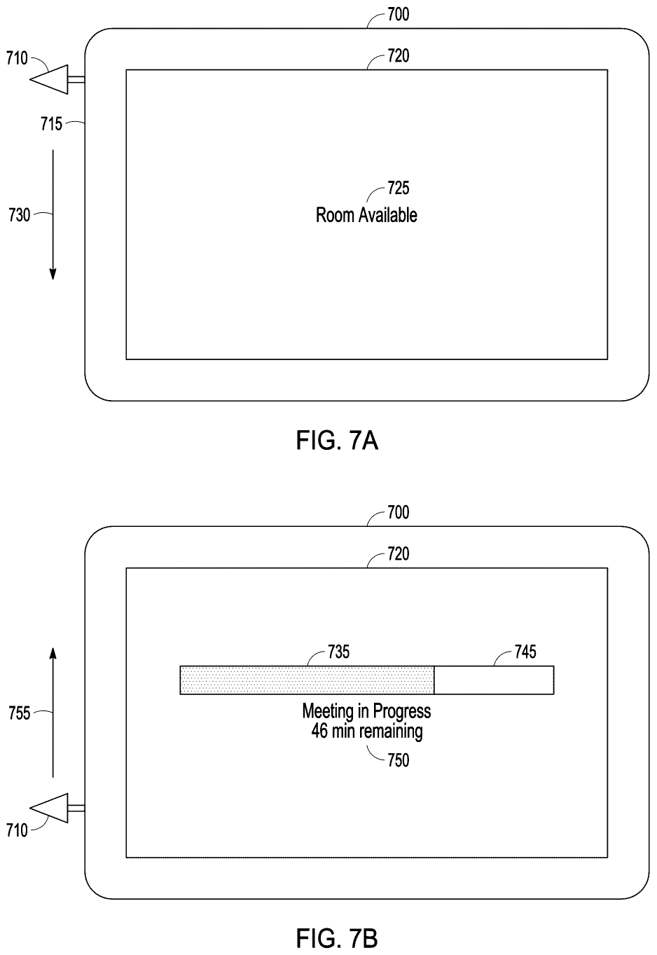

FIG. 7A is a perspective view of panel 700 having a physical slider 710 located on a side 715 of the panel 700. Panel 700 includes a display 720 and if an associated room is currently not reserved, the text “Room Available” 725 may be shown along with actual schedule information if desired. An arrow 730 shows a direction for movement of slider 710 to initiate reservation of the room for an ad hoc meeting.

FIG. 7B is a perspective view of the panel 700 of FIG. 7A resulting from movement and release of the slider 710. A bar 735 is displayed in response to such movement having a first portion 740 graphically indicating an amount of time the room has been reserved based on movement of the slider 710. A second portion 745 of the bar 735 graphically indicates an amount of time the slider 710 can be moved to increase the amount of time up to the next scheduled meeting. Text 750 indicates “Meeting in Progress 46 min remaining. Further movement of the slider 710 in the direction of arrow 755 may decrease the time or in the direction of arrow 730 to increase the time. Release of the dial-based slider 710 or a threshold amount of time for the dial-based slider 710 such as three seconds, results in the meeting being scheduled and the colors of the slider 710 and the bar 735 turning red.

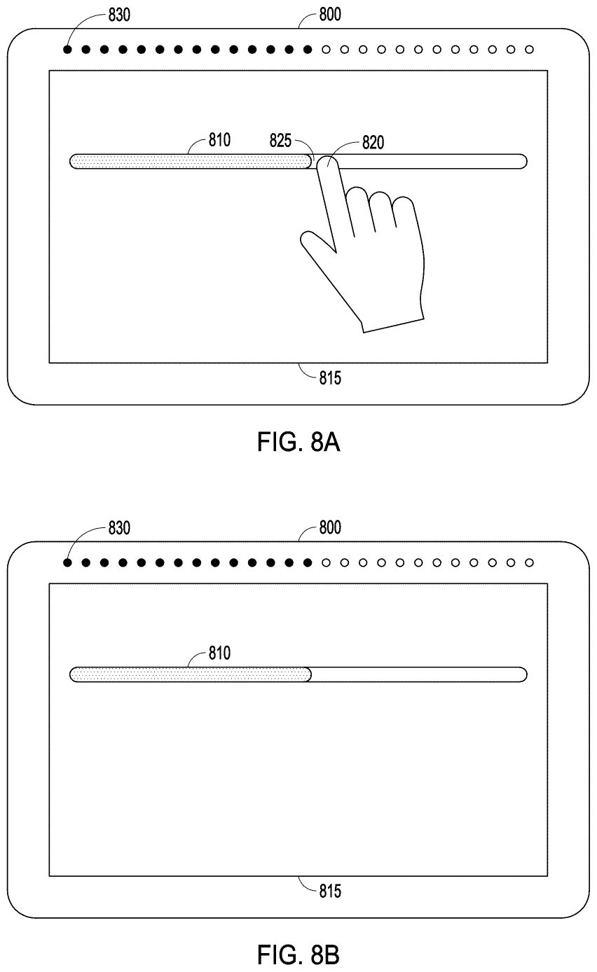

FIG. 8A is a perspective view of touchscreen panel 800 having a graphic bar slider 810 on display portion 815 of the panel 800. The graphic bar slider 810 indicates availability of an associated room for an ad hoc meeting. A user finger 820 may contact the graphic bar slider 810 at any point and move along the bar to a desired point 825 to reserve the room for a time represented to the left of the desired point 825 which may show the color green. A series of lights 830 along a top or other area of the panel 800 may also turn green to visually represent the amount of time.

FIG. 8B is a perspective view of the panel 800 of FIG. 8A resulting from release of the slider 810. Release of the graphic bar slider 810 results in the meeting being scheduled and the colors of the graphic bar slider turning red to indicate time remaining the ad hoc meeting. The red color of the graphic bar slider 810 as well as the lights 830 may move to the left as the meeting progresses to visually represent the amount of time remaining.

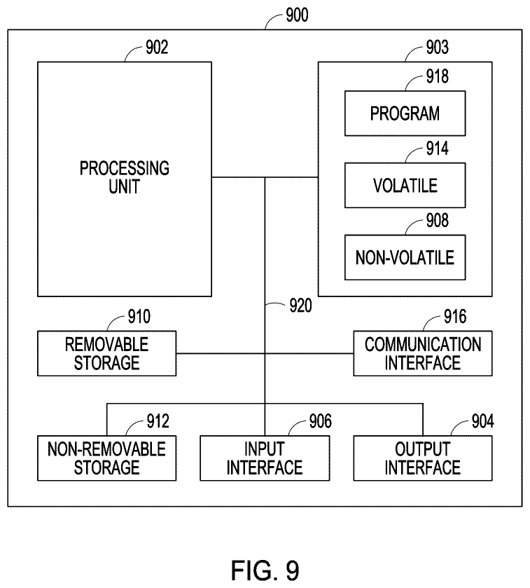

FIG. 9 is a block schematic diagram of a computer system 900 for implementing one or more of the panel or scheduling system or platform and for performing methods and algorithms according to example embodiments. All components need not be used in various embodiments.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server-based storage.

Note also that an SSD may include a processor on which the parser may be run, allowing transfer of parsed, filtered data through I/O channels between the SSD and main memory.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 918 may be used to cause processing unit 902 to perform one or more methods or algorithms described herein.

### Examples:

1. A computer implemented method includes displaying a scheduling interface on a scheduling panel associated with a room. The scheduling interface includes a moveable slider. Movement of the moveable slider is sensed and converted into a signal representing a length of time. Release of the moveable slider is detected and ad hoc meeting information is generated in response to release of the moveable slider. The meeting information includes a room identifier, start time, and end time. The meeting information is uploaded into a scheduling system.
2. The method of example 1 wherein the start time corresponds to a current time.
3. The method of any of examples 1-2 wherein the moveable slider includes a physical slider supported by the scheduling panel.
4. The method of any of examples 1-2 wherein the moveable slider includes an icon displayed on a touchscreen of the scheduling panel.
5. The method of any of examples 1-4 and further comprising displaying a bar on a touchscreen display of the scheduling panel, the bar graphically representing a meeting time remaining.
6. The method of example 5 wherein a length of the bar decreases as the meeting occurs.
7. The method of any of examples 5-6 wherein the bar has a red color in response to release of the moveable slider.
8. The method of any of examples 1-7 and further including displaying a status of the room on a display of the scheduling panel, the status of the room identifying current and future scheduled meeting times and open times.
9. A device includes a scheduling panel associated with a meeting room, a touchscreen display supported by the scheduling panel a moveable slider supported by the scheduling panel, and a processor configured to sense movement of the moveable slider, convert the movement into a signal representing a length of time, detect release of the moveable slider, generate ad hoc meeting information in response to release of the moveable slider, the meeting information including a room identifier, start time, and end time, and upload the meeting information into a scheduling system.
10. The device of example 9 wherein the start time corresponds to a current time.
11. The device of any of examples 9-10 wherein the moveable slider includes a physical slider supported by the scheduling panel.
12. The device of any of examples 9-10 wherein the moveable slider includes an icon displayed on a touchscreen display.
13. The device of any of examples 9-12 wherein the processor is further configured to display a bar on a touchscreen display of the scheduling panel, the bar graphically representing a meeting time remaining and wherein a length of the bar decreases as the meeting occurs.
14. The device of any of examples 9-13 wherein the processor is further configured to display a status of the room on a display of the scheduling panel, the status of the room identifying current and future scheduled meeting times and open times.
15. A device includes a processor, a touchscreen display, and a memory device coupled to the processor and having a program stored thereon for execution by the processor to perform operations. The operations include displaying a scheduling interface on the display that is associated with a room, the scheduling interface including a moveable slider, converting movement of the moveable slider into a signal representing a length of time, detecting release of the moveable slider, generating ad hoc meeting information in response to release of the moveable slider, the meeting information including a room identifier, start time, and end time, and uploading the meeting information into a scheduling system.
16. The device of example 15 wherein the start time corresponds to a current time.
17. The device of any of examples 15-16 wherein the moveable slider includes a physical slider supported by the touchscreen display.
18. The device of any of examples 15-16 wherein the moveable slider includes an icon displayed on the touchscreen display.
19. The device of any of examples 15-18 wherein the operations further includes displaying a bar on the touchscreen display, the bar graphically representing a meeting time remaining, wherein a length of the bar decreases as the meeting occurs, and herein the bar has a red color in response to release of the moveable slider.
20. The device of example 15 wherein the operations further include displaying a status of the room on the touchscreen display, the status of the room identifying current and future scheduled meeting times and open times.

The functions or algorithms described herein may be implemented in software in one embodiment. The software may consist of computer executable instructions stored on computer readable media or computer readable storage device such as one or more non-transitory memories or other type of hardware-based storage devices, either local or networked.

Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
displaying a scheduling interface on a scheduling panel associated with a room, the scheduling interface including a moveable slider;
sensing movement of the moveable slider,
converting the movement into a signal representing a length of time;
detecting release of the moveable slider;
generating ad hoc meeting information in response to release of the moveable slider, the meeting information including a room identifier, start time, and end time; and
uploading the meeting information into a scheduling system.

2. The method of claim 1 wherein the start time corresponds to a current time.

3. The method of claim I wherein the moveable slider comprises a physical slider supported by the scheduling panel.

4. The method of claim 1 wherein the moveable slider comprises an icon displayed on a touchscreen of the scheduling panel.

5. The method of claim I and further comprising displaying a bar on a touchscreen display of the scheduling panel, the bar graphically representing a meeting time remaining.

6. The method of claim 5 wherein a length of the bar decreases as the meeting Occurs.

7. The method of claim 5 wherein the bar has a red color in response to release of the moveable slider.

8. The method of claim 1 and further comprising displaying a status of the room on a display of the scheduling panel, the status of the room identifying current and future scheduled meeting times, wherein movement of the moveable slider is limited up until a time of a next scheduled meeting such that further movement of the moveable slider will not increase the length of time beyond the next scheduled meeting.

9. A device comprising:
a scheduling panel associated with a meeting room;
a touchscreen display supported by the scheduling panel;
a moveable slider supported by the scheduling panel; and
a processor configured to:
sense movement of the moveable slider;
convert the movement into a signal representing a length of time;
detect release of the moveable slider;
generate ad hoc meeting information in response to release of the moveable slider, the meeting information including a room identifier, start time, and end time; and
upload the meeting information into a scheduling system.

10. The device of claim 9 wherein the start time corresponds to a current time.

11. The device of claim 9 wherein the moveable slider comprises a physical slider supported by the scheduling panel.

12. The device of claim 9 wherein the moveable slider comprises an icon displayed On a touchscreen display.

13. The device of claim 9 wherein the processor is further configured to display a bar on a touchscreen display of the scheduling panel, the bar graphically representing a meeting time remaining and wherein a length of the bar decreases as the meeting occurs.

14. The device of claim 9 wherein the operations further comprise displaying a status of the room on the touchscreen display, the status of the room identifying current and future scheduled meeting times, wherein movement of the moveable slider is limited up until a time of a next scheduled meeting such that further movement of the moveable slider will not increase the length of time beyond the next scheduled meeting.

15. A device comprising:
a processor;
a touchscreen display; and
a memory device coupled to the processor and having a program stored thereon for execution by the processor to perform operations comprising:
displaying a scheduling interface on the display that is associated with a room, the scheduling interface including a moveable slider;
converting movement of the moveable slider into a signal representing a length of time;
detecting release of the moveable slider;
generating ad hoc meeting information in response to release of the moveable slider, the meeting information including a room identifier, start time, and end time; and
uploading the meeting information into a scheduling system.

16. The device of claim 15 wherein the start time corresponds to a current time.

17. The device of claim 15 wherein the moveable slider comprises a physical slider supported by the touchscreen display.

18. The device of claim 15 wherein the moveable slider comprises an icon displayed on the touchscreen display.

19. The device of claim 15 wherein the operations further comprise displaying a bar on the touchscreen display, the bar graphically representing a meeting time remaining, wherein a length of the bar decreases as the meeting occurs, and herein the bar has a red color in response to release of the moveable slider.

20. The device of claim 15 wherein the operations further comprise displaying a status of the room on the touchscreen display, the status of the room identifying current and future scheduled meeting times, wherein movement of the moveable slider is limited up until a time of a next scheduled meeting such that further movement of the moveable slider will not increase the length of time beyond the next scheduled meeting.
